(19) United States
(12) Patent Application Publication
(10) Pub. No.: US 2010/0203309 A1
(43) Pub. Date: Aug. 12, 2010

(54) STRETCH HOODER FILM AND METHOD THEREOF

(75) Inventor: Thea Ellingson, Northfield, MN (US)

Correspondence Address: BARNES & THORNBURG LLP, 11 SOUTH MERIDIAN, INDIANAPOLIS, IN, 46204, US

(73) Assignee: Berry Plastics Corporation, Evansville, IN (US)

(21) Appl. No.: 12/367,461

(22) Filed: Feb. 6, 2009

(51) Int. Cl. B32B 27/32; B32B 27/00; B29C 49/04

(52) U.S. Cl. 428/220; 428/500; 264/514

(57) ABSTRACT

A stretch hooder for palletizing goods is described. The stretch hooder is a one-piece hood made in the machine direction from a continuous roll of lay flat tubing or gusseted film. The stretch hooder film may be stretched over a load and secured under the pallet. Stretch hooders are used for applications where pallet loads require five-sided protection that may also encounter stress during shipping or where products are sensitive to heat, thus preventing the use of other palletizing approaches.

### BACKGROUND

The present disclosure relates to multi-layer films for stretch hooder applications, and to a method of making the same. More particularly, the present disclosure relates to polymeric co-extruded multilayer films useful as stretch hooders and a process for making the same.

### SUMMARY

According to the present disclosure, a multi-layer stretch film is described which has a first exterior layer, a second exterior layer and an interior polymer layer. The film has properties that make it useful for stretch hooder packaging; particularly, the stretch hooder of the present disclosure exhibits improved machinability, load retention, puncture resistance, tear resistance, and tensile strength. In illustrative embodiments, a stretch hooder film with multiple layers is described.

A stretch hooder is a one-piece hood made in the machine direction from a continuous roll of lay flat tubing or gusseted film. The stretch hooder film may be stretched over a load and secured under the pallet. Stretch hooders are used for applications where pallet loads require five-sided protection that may also encounter stress during shipping or where products are sensitive to heat, thus preventing the use of other palletizing approaches.

Additional features of the present disclosure will become apparent to those skilled in the art upon consideration of illustrative embodiments exemplifying the best mode of carrying out the disclosure as presently perceived.

### DETAILED DESCRIPTION

The present disclosure is related to multi-layer stretch hooder comprising a first exterior layer, a second exterior layer and an interior polymer layer interposed between the first exterior layer and a second exterior layer.

Stretch hooders have many beneficial attributes, for example, pallet loads that have been packaged using stretch hooders are more secured for transportation than stretch wrap or shrink films and exhibit advantageous tension in both horizontal and vertical directions allowing for the finished goods to be pressed downwards on the pallet preventing the load from shifting. Furthermore, stretch hooders do not require the use of a heat gun or tunnel or glue; thereby reducing the risk of fire and the emission of volatile organic compounds.

In accordance with embodiments of the present disclosure, the product and method described herein exhibits surprising improvements in key stretch hooder performance characteristics. Particularly, the disclosed composition exhibits improved machinability, load retention, puncture resistance, tear resistance, and tensile strength while maintaining the generally recognized advantages of stretch hooders in that they are environmentally safe, cost-effective, energy-saving, and convenient.

Stretch hooders can be used on Lachenmeier, Moellers, Beumer, MSK, Bocedi, or other commercially available stretch hood equipment. A stretch hooder film can be used to fabricate a five-sided bag to contain pallet loads of products including: appliances (e.g., wash machines, dryers, stoves, and refrigerators); building products (e.g., tile, laminate flooring, brick, blocks, shingles, and/or cement (50-2,000 lb bags or sacks)), beverage packaging (e.g., glass bottles, aluminum cans, and PET or PP bottles), industrial chemicals in bags or boxes (e.g., pellets, powders, granules), or any product that needs moisture barrier, load containment, and/or stretch holding force.

As used herein, linear low-density polyethylene (LLDPE) is used to describe a copolymer of ethylene and an alpha olefin comonomer made through a single site catalyzed reaction (e.g., through a metallocene catalyzed reaction), or Ziegler Natta catalysts. Included within the scope of this disclosure are physical blends of LLDPE with an elastomer or high pressure low density polyethylene. LLDPE, as used herein, includes polymers made through non-metallocene or post-metallocene catalyzed reactions resulting in a copolymer of ethylene and an alpha olefin copolymer. LLDPE includes copolymers made with various alpha olefin monomers including 1-butene, 3-methyl-1-butene, 1-propylene, 3-methyl-1-pentene, 1-hexene, 4-methyl-1-pentene, 3-methyl-1-hexene, 1-octene or 1-decene. The alpha olefin comonomer may be incorporated from about 1% to about 20% by weight of the total weight of the polymer. In other embodiments the alpha olefin comonomer may be incorporated from about 1% to about 10% by weight of the total weight of the polymer. LLDPE also includes copolymers incorporating long-chain branching (e.g. chains containing as many as 300 carbons). Reference may be made to U.S. Pat. Nos./U.S. Publ. Nos. 3,645,992, 4,011,382, 4,205,021, 4,302,566, 6,184,170, 6,919,467 and 2008/0045663 for examples of resins which may be particularly useful herein.

As used herein, the term polypropylene (PP) includes polymers with various molecular weights, densities, and tacticities synthesized from propylene monomers. The term PP is intended to include polymers which are homopolymers of propylene or copolymers of propylene or other lower or higher alpha olefins, such as ethylene. The term PP, within the scope of this disclosure, includes PP characterized as soft PP.

As used herein, the term ethylene acrylate copolymers (EAC) include polymers with various molecular weights, densities, and tacticities synthesized from ethylene and acrylate monomers. Included within the scope of this disclosure are copolymers such as ethylene methyl acrylate (EMA), ethylene ethyl acrylate (EEA), ethylene butyl acrylate (EBA) and ethylene vinyl acetate (EVA). In one embodiment, the EAC are random copolymers. In another embodiment, the EAC is a block copolymer. In yet another embodiment, the EAC is phase separated, that is, the copolymer is polymerized in a manner such that the blocks are immiscible. Accordingly, the EAC of the present disclosure includes polymers that have ordered microstructures. Also included within the scope of this disclosure are EAC polymers exhibiting ordered morphologies such as spheres, cylinders, and lamellae, ordered bicontinuous double-diamond, ordered tricontinuous double-diamond or perforated-lamellar morphologies.

While specific polymer compositions are referred to herein, one of ordinary skill in the art will appreciate that polymers or polymer blends with substantially equivalent physical properties could be substituted; yet remain within the scope and spirit of the present disclosure. In particular, those polymers having substantially equivalent melt indexes (MI) and flow ratios (FR) may be particularly suitable. One of ordinary skill in the art will appreciate that MI is an indication of molecular weight, wherein higher MI values correspond to low molecular weights. At the same time, MI is a measure of a melted polymer's ability to flow under pressure. FR is used as an indication of the manner in which rheological behavior is influenced by the molecular weight distribution of the material.

In illustrative embodiments, the film of the present disclosure is from about 1.0 mil to about 10.0 mil in thickness. In another embodiment, the film is from about 2.5 mil to 5.0 mil in thickness. As used herein, the unit mil is used as a thickness equal to one thousandth (10⁻³) of an inch which is approximately equal to 0.0254 millimeters.

In illustrative embodiments, the film described herein may be manufactured on a blown film line. In illustrative embodiments, the blow-up ratio used to manufacture this formula is between about 1:1 to about 5:1. In another embodiment, the blow-up ratio used to manufacture the formula is between about 2.5:1 to 3.5:1.

In illustrative embodiments, the film has a structure of A, B, A or A, B, C. In one embodiment, layer A may be a first exterior layer. In another embodiment, layer A may also be a second exterior layer. In another embodiment, layer C may be a second exterior layer. In one embodiment, layer B may be a core or interior layer. In one embodiment, a layer A comprises about 10% to about 30% of the weight percentage of the entire film. Accordingly, in an A, B, A structure, the total weight of the film may be comprised of about 20% to about 80% by weight of the composition comprising layer A. In another embodiment, a layer of A comprises about 15% to about 25% of the weight percentage of the entire film. In one embodiment, layer B comprises about 30% to about 80% of the weight percentage of the entire film. In another embodiment, layer B comprises about 40% to about 50% of the weight percentage of the entire film. In one embodiment, layer C comprises between about 10% to about 30% of the weight percentage of the entire film. In another embodiment, layer C comprises about 15% to about 25% of the weight percentage of the entire film. While described as a three layer film, within the scope of this disclosure are films in which additional layers are incorporated, such as a four to thirteen layer film, wherein the interior layer is described as herein. For example, a film comprising layers A, B, C, D and E may be substantially equivalent to the film described herein if the layers B, C, or D or any combination thereof has a composition similar to the composition of the interior layer as described herein.

In illustrative embodiments, layer A comprises LLDPE. In one embodiment layer A comprises an LLDPE with a MI of about 0.5 to about 3 g/10 min. In another embodiment the LLDPE has a density of from about 0.89 g/cm³ to about 0.95 g/cm³. In yet another embodiment, the LLDPE has a density from about 0.906 g/cm³ to about 0.925 g/cm³. In one embodiment, layer A comprises a polymer with equivalent MI and density as LLDPE. In another embodiment, layer A comprises a combination of two LLDPE resins. In another embodiment, layer A further comprises UV weatherability concentrates, antiblock, colorants, and/or antistatic additives.

In illustrative embodiments, layer B comprises PP. In one embodiment, layer B comprises a PP with a MI of 0.6 to about 1 g/10 min. In another embodiment, layer B comprises a PP with a FR of about 0.8 to about 1. In another embodiment, layer B comprises a PP with a FR of about 0.87 to about 0.91. In one embodiment, layer B comprises a polymer with equivalent MI and FR as PP. In one aspect, the PP in layer B is blended with additive polymers such that the weight percentage of PP in layer B is from about 20% to about 60% of the total weight of layer B. In another aspect, the level of elasticity, the.puncture resistance, the snap back and the stretch recovery properties may be tailored by varying the weight percentage of PP in layer B. For example, various customers' specifications may require different compositions such that their products' integrity is maintained as it is transported from the manufacturers' site to the end users. In another embodiment, layer B further comprises UV weatherability concentrates and colorants.

In illustrative embodiments, layer B further comprises an EAC. In one aspect, the EAC may be considered an additive polymer. In another embodiment, the EAC may be a random copolymer. In another embodiment, the EAC may be a block copolymer. In another embodiment the EAC may be a graft copolymer. In one embodiment, the layer B comprises an additive polymer with a MI of from about 0.5 to about 3 g/10 min. In one embodiment, layer B may include an additive polymer with a similar MI as the EAC described herein. In another embodiment, the EAC comprises a polymer composition having from about 4% to about 30% acrylate by weight.

In illustrative embodiments, the EAC may exhibit substantial phase separation. In one embodiment, the EAC may be ordered. In another embodiment, layer B may include a polymer with similar phase separation ordering as an EAC. In another embodiment, layer B comprises a thermoplastic elastomer, an elastic fiber, or a surfactant with properties substantially like those of an EAC, as described herein. In yet another embodiment, layer B comprises from about 40% to about 60% of an EAC by weight. In one embodiment, layer B comprises an EAC having a spherical ordered morphology. In another embodiment, layer B comprises an EAC having a cylindrical ordered morphology. In yet another embodiment, layer B comprises an EAC having a lamellar ordered morphology. In one embodiment, layer B comprises EBA polymers having a bicontinuous double-diamond or ordered tricontinuous double-diamond ordered morphology. Surprisingly, an EAC may be used to improve melt strength of the core while and with the mutual effect that both interstitial and intrastitial bonding of the PP and LLDPE in the layers improves unexpectedly. These improvements in interstitial and intrastitial bonding improvements result in surprising improvements in the films performance, both in function and as demonstrated through analytical testing.

In illustrative embodiments, layer C comprises LLDPE. In one embodiment layer C comprises an LLDPE with a MI of about 0.5 to about 3 g/10 min. In another embodiment the LLDPE has a density of from about 0.89 g/cm³ to about 0.95 g/cm³. In yet another embodiment, the LLDPE has a density from about 0.906 g/cm³ to about 0.925 g/cm³. In one embodiment layer C comprises a polymer with equivalent MI and density as LLDPE. In one embodiment, layer C comprises a combination of two LLDPE resins. In another embodiment, layer C further comprises UV weatherability concentrates, antiblock, colorants, and/or antistatic additives.

In illustrative embodiments, the first and/or second exterior layers may be treated to enhance certain properties. In one embodiment, the first and/or second exterior layers may be corona treated. In another embodiment, the first and/or second exterior layers may be treated for printing, treated as to add colorants, treated as to add UV weatherability, slip, or antistatic properties.

The film performance of the films and stretch hooders described herein are unexpectedly improved as compared to other materials known in the art. In one embodiment, tensile strength at break (established by ASTM D-882) is greater than 4000 psi (pounds per square inch) in the machine direction and greater than 3500 psi in the transverse direction for a nominally sized 3.5 mil film thickness. In another embodiment, tensile strength at break is from about 4500 to about 6000 psi in the machine direction and from 4000 to about 5500 psi in the transverse direction for a nominally sized 3.5 mil film thickness. In another embodiment, elongation at break (established by ASTM D-882) is greater than about 1200 percent in the machine direction and greater than about 1000 percent in the transverse direction for a nominally sized 3.5 mil film thickness. In another embodiment, elongation at break is from about 1300 to about 1500 percent in the machine direction and from about 1100 to about 1400 percent in the transverse direction for a nominally sized 3.5 mil film thickness. In another embodiment, the Elmendorf Tear strength (established by ASTM D-1922) is greater than about 800 g in the machine direction and greater than about 1200 g in the transverse direction for a nominally sized 3.5 mil film thickness. In yet another embodiment, the Elmendorf Tear strength is from about 900 to about 1400 g in the machine direction and from about 1300 to about 1700 g in the transverse direction for a nominally sized 3.5 mil film thickness. In another embodiment, the dart impact strength (established by ASTM D-1709) is greater than about 1700 g for a nominally sized 3.5 mil film thickness. In yet another embodiment, the dart impact strength (established by ASTM D-1709) is from about 1800 to about 2500 g for a nominally sized 3.5 mil film thickness. In another embodiment, the puncture resistance (established by ASTM D-2582) is greater than about 1200 g/mil. In another embodiment, the puncture resistance (established by ASTM D-2582) is from about 1200 to about 1500 g/mil. In yet another embodiment, the heat seal strength (established by ASTM D-F88) is greater than about 4.5 lb. In yet another embodiment, the heat seal strength (established by ASTM D-F88) is about 5.5 lb. In another embodiment, the recovery from initial stretch is greater than 60 percent of the total initial stretch when the total initial stretch is less than or equal to about 70 percent by length of the film in the transverse direction. In yet another embodiment, the recovery from initial stretch is greater than 70 percent of the total initial stretch when the total initial stretch is less than or equal to about 70 percent by length of the film in the transverse direction. In yet another embodiment, the recovery from initial stretch is greater than 70 percent of the total initial stretch when the total initial stretch is less than or equal to about 100 percent by length of the film in the transverse direction. Accordingly, the combination of the unique film structure having unique compositions therein, and the method of manufacturing the same, has contributed to surprising performance improvements for stretch hooders films.

In one aspect, the first and/or second exterior layers are used to provide skins for structural support and to prevent blocking from the comparatively soft core. In this respect, the exterior layer enhances sealability and provides barrier protection to the internal layer(s). In another aspect, the interior layer or core provides puncture resistance, a moisture barrier, and elasticity properties in both hot and cold environments that make the film useful as a stretch hooder. Furthermore, the interior layer or core provides elastic recovery properties and load containment properties which exceed those observed or expected. In another aspect, the film structure and extruder design can be varied to meet various specifications dependent on the types of additives needed by the customer.

In one embodiment, described herein is a stretch hooder comprising a multi-layer blown film comprising a first exterior layer, a second exterior layer and an interior polymer layer configured as a five-sided bag, wherein the interior polymer layer comprises a blend of polypropylene and an EAC. In another embodiment the interior polymer layer comprises a polymer composition having from about 20% to about 60% polypropylene by weight and from about 40% to about 80% EAC by weight. In another embodiment, the interior polymer layer comprises from about 30% to about 60% of the weight of the multi-layer blown film. In yet another embodiment, the interior polymer layer further comprises UV weatherability concentrates or colorants.

In one embodiment, described herein is a method of making a multi-layer stretch hooder film comprising co-extruding a predetermined number of polymer compositions, blow molding a multi-layer film on a blown film line, and configuring the film as a five sided bag; wherein the predetermined number of polymer compositions is three or greater and one polymer composition includes at least 40% of an EAC. In another embodiment, the blow molding of a multi-layer film on a blown film line includes using blow-up ratio of between about 1:1 to about 5:1. In another embodiment, the blow molding of a multi-layer film on a blown film line includes a using blow-up ratio of between about 2.5:1 to 3.5:1. In yet another embodiment, the method of making a multi-layer stretch layer includes using a polymer composition including at least 40% of an EAC co-extruded between at least one layer of LLDPE and another polymer layer. In another embodiment, the other polymer layer is LLDPE or a blend thereof.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. To facilitate understanding, like reference numerals have been used, where possible, to designate like elements common to the figure.

1. A stretch hooder comprising
a multi-layer blown film comprising a first exterior layer, a second exterior layer and an interior polymer layer configured as a five sided bag, wherein the interior polymer layer comprises a blend of polypropylene and an ethylene acrylate copolymer.

2. The stretch hooder of claim 1, wherein the interior polymer layer comprises a polymer composition having from about 20% to about 60% polypropylene by weight and from about 40% to about 80% ethylene acrylate copolymer by weight.

3. The stretch hooder of claim 1, wherein the interior polymer layer comprises from about 30% to about 80% of the weight of the multi-layer blown film.

4. The stretch hooder of claim 1, wherein the interior polymer layer further comprises UV weatherability concentrates.

5. The stretch hooder of claim 1, wherein the interior polymer layer further comprises colorants.

6. The stretch hooder of claim 1, wherein the multilayer blown film has a thickness in the range from about 1.0 mil to about 10.0 mil.

7. The stretch hooder of claim 1, wherein the multilayer blown film comprises from about 10% to about 30% by weight of the first exterior layer and from about 10% to about 30% by weight of the second exterior.

8. The stretch hooder of claim 1, wherein the first exterior layer comprises linear low density polyethylene.

9. The stretch hooder of claim 1, wherein the second exterior layer comprises linear low density polyethylene.

10. The stretch hooder of claim 1, wherein the ethylene acrylate copolymer comprises phase-separated spherically ordered ethylene acrylate copolymer.

11. The stretch hooder of claim 1, wherein the ethylene acrylate copolymer comprises phase-separated cylindrically ordered ethylene acrylate copolymer.

12. The stretch hooder of claim 1, wherein the ethylene acrylate copolymer comprises phase-separated lamellar ordered ethylene acrylate copolymer.

13. The stretch hooder of claim 1, wherein the multilayer blown film has a thickness of at least 3.5 mil and the tensile strength at break is greater than 4000 psi in the machine direction and greater than 3500 psi in the transverse direction.

14. The stretch hooder of claim 1, wherein the multilayer blown film has a thickness of at least 3.5 mil and the tensile strength at break is from about 4500 to about 6000 psi in the machine direction and from 4000 to about 5500 psi in the transverse direction.

15. The stretch hooder of claim 1, wherein the multilayer blown film has a thickness of at least 3.5 mil and the elongation at break is greater than about 1200 percent in the machine direction and greater than about 1000 percent in the transverse direction.

16. The stretch hooder of claim 1, wherein the multilayer blown film has a thickness of at least 3.5 mil and the elongation at break is from about 1300 to about 1500 percent in the machine direction and from about 1100 to about 1400 percent in the transverse.

17. The stretch hooder of claim 1, wherein the multilayer blown film has a thickness of at least 3.5 mil and the Elmendorf Tear strength (is greater than about 800 g in the machine direction and greater than about 1200 g in the transverse direction.

18. The stretch hooder of claim 1, wherein the multilayer blown film has a thickness of at least 3.5 mil and the Elmendorf Tear strength is from about 900 to about 1400 g in the machine direction and from about 1300 to about 1700 g in the transverse direction.

19. The stretch hooder of claim 1, wherein the multilayer blown film has a thickness of at least 3.5 mil and the dart impact strength is greater than about 1700 g.

20. The stretch hooder of claim 1, wherein the multilayer blown film has a thickness of at least 3.5 mil and the dart impact strength is from about 1800 to about 2500 g.

21. The stretch hooder of claim 1, wherein the puncture resistance is greater than about 1200 g/mil.

22. The stretch hooder of claim 1, wherein the heat seal strength is about 5.5 lb.

23. The stretch hooder of claim 1, wherein the recovery from initial stretch is greater than 60 percent of the total initial stretch when the total initial stretch is less than or equal to about 70 percent by length of the film in the transverse direction.

24. The stretch hooder of claim 1, wherein the recovery from initial stretch is greater than 70 percent of the total initial stretch when the total initial stretch is less than or equal to about 70 percent by length of the film in the transverse direction.

25. The stretch hooder of claim 1, wherein the recovery from initial stretch is greater than 70 percent of the total initial stretch when the total initial stretch is less than or equal to about 100 percent by length of the film in the transverse direction.

26. A method of making a multi-layer stretch hooder film comprising
co-extruding a predetermined number of polymer compositions,
blowing the polymer compositions in a multi-layer film, and
configuring the film as a five-sided bag,
wherein the predetermined number of polymer compositions is three or greater and one polymer composition includes at least 40% of an ethylene acrylate copolymer.

27. The method of claim 26 wherein the step of blow molding a multi-layer film includes a using blow-up ratio of between about 1:1 to about 5:1.

28. The method of claim 26 wherein the step of blow molding a multi-layer film on a blown film line includes a using blow-up ratio of between about 2.5:1 to 3.5:1.

29. The method of claim 26 wherein the polymer composition including at least 40% of an ethylene acrylate copolymer is co-extruded such that it is oriented between at least one layer of linear low density polyethylene and at least one layer of another polymer layer.

30. A film comprising
a first exterior layer, a second exterior layer and an interior polymer layer, wherein the interior polymer layer comprises a blend of from about 20% to about 60% polypropylene and from about 40% to about 60% of an ordered ethylene acrylate copolymer.

31. The film of claim 30, wherein the ordered ethylene acrylate copolymer is spherically ordered.

32. The film of claim 30, wherein the ordered ethylene acrylate copolymer is cylindrically ordered.

33. The film of claim 30, wherein the ordered ethylene acrylate copolymer is lamellar ordered.
